(19) United States
(12) Patent Application Publication
(10) Pub. No.: US 2020/0228484 A1
(43) Pub. Date: Jul. 16, 2020

(54) MARK MESSAGE AS UNREAD

(71) Applicant: Zipwhip, Inc., Seattle, WA (US)

(72) Inventors: Roman Prigozhin, Woodinville, WA (US); Alan Capps, Monroe, WA (US); Ali Serghini, Seattle, WA (US); James Lapic, Kirkland, WA (US)

(21) Appl. No.: 15/929,089

(22) Filed: Jan. 11, 2019

(51) Int. Cl. H04L 12/58; H04W 4/14

(52) U.S. Cl. CPC H04L 51/24; H04L 51/38; H04W 4/14; H04L 51/22

(57) ABSTRACT

A method for marking a message as unread includes: receiving an electronic message at an account and controlling a user interface to display the electronic message. Via the user interface, a selection of the displayed message is received from a user. In response, a status of the displayed message is set as read, and the user interface is controlled to display at least one message option for selection by the user. The at least one message option includes a mark-as-unread option. Via the user interface, a selection of the mark-as-unread option is received for the displayed message. In response, the status of the displayed message is set as unread. Setting the status of the displayed message as unread causes a notification to be sent to at least the user, the notification indicating the displayed message as an unread message, in order to increase a priority level of the displayed message.

### BACKGROUND

An organization such a corporate or business entity includes users. The users may range from owners and supervisors to non-supervisory employees and members. One or more accounts may be provided in the organization, for use by the users in sending and receiving messages. The messages may be sent, or received from, within or outside of the organization. In this regard, a message received from a client or customer of the organization may be treated as a task item that is to be performed by one or more users.

### BRIEF SUMMARY

According to at least one embodiment, a method for marking a message as unread includes: receiving an electronic message at an account; and controlling a user interface to display the electronic message. Via the user interface, a selection of the displayed message is received from a user. In response to receiving the selection of the displayed message, a status of the displayed message is set as read, and the user interface is controlled to display at least one message option for selection by the user, wherein at least one message option includes a mark-as-unread option. Via the user interface, a selection of the mark-as-unread option is received for the displayed message. In response to receiving the selection of the mark-as-unread option, the status of the displayed message is set as unread. Setting the status of the displayed message as unread causes a notification to be sent to at least the user, the notification indicating the displayed message as an unread message, in order to increase a priority level of the displayed message.

According to least another embodiment, a computing apparatus includes: a processor; and a memory storing instructions. When executed by the processor, the instructions configure the apparatus to: receive an electronic message at an account; and control a user interface to display the electronic message. Via the user interface, a selection of the displayed message is received from a user. In response to receiving the selection of the displayed message, a status of the displayed message is set as read, and the user interface is controlled to display at least one message option for selection by the user, wherein at least one message option includes a mark-as-unread option. Via the user interface, a selection of the mark-as-unread option is received for the displayed message. In response to receiving the selection of the mark-as-unread option, the status of the displayed message is set as unread. Setting the status of the displayed message as unread causes a notification to be sent to at least the user, the notification indicating the displayed message as an unread message, in order to increase a priority level of the displayed message.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram illustrating a system for marking a message as unread, in accordance with at least one embodiment

FIG. 2 illustrates a screenshot in accordance with one embodiment.

FIG. 3 illustrates an enlarged view of a portion of the screenshot of FIG. 2 in accordance with at least one embodiment.

FIG. 4 illustrates a screenshot in accordance with one embodiment.

FIG. 5 is a flowchart of a method of marking a message as unread in accordance with one embodiment.

FIG. 6 illustrates a simplified system in which a server and a client device are communicatively coupled via a network.

FIG. 7 is an example block diagram of a computing device that may incorporate embodiments of the present invention.

### DETAILED DESCRIPTION

In a customer service environment, messages such as SMS messages received from customers may be regarded as a high-priority medium (e.g., a medium that is higher in priority than other mediums such as e-mail). For example, each of such messages may represent a task item that is to be performed or serviced. As such, shorter response times may be sought. However—after such a message has been read by one user, it may be difficult to maintain a priority level of the message within a corporate or business entity. For example, the user may neglect to follow through on the corresponding task item, in the midst of other task items. As another example, even if the user forwards the message to another user, it is possible that the message will not receive a desired level of attention. According to embodiments disclosed herein—after a message is read, a user may mark the message as unread, to identify the message as remaining in need of attention and/or servicing, and, in a more global manner, to draw the attention of one or more other users via notifications. As such, a priority level of the message is increased.

In a customer service environment employing text messages, such features may be beneficial in that text messages such as SMS messages are often regarded as a high-priority medium (e.g., a medium that is higher in priority than other mediums such as e-mail) for which shorter delays in responding are sought. By marking a particular message as unread, a user effectively identifies the message as remaining in need of attention and/or servicing, and, in a more global manner, draws the attention of one or more other users via notifications. As such, a priority level of the message is increased.

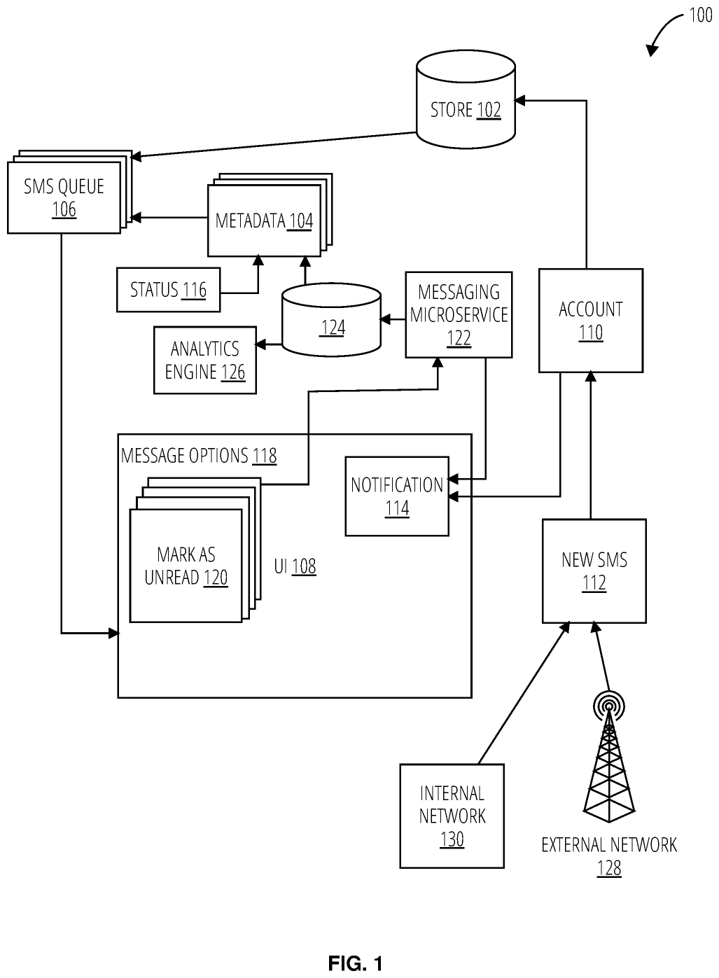

FIG. 1 is a diagram illustrating a system 100 for marking a message as unread, in accordance with at least one embodiment.

An electronic message 112 is received at an account 110. As will be described herein with reference to various embodiments, the electronic message 112 is a Short Message Service (SMS) message. However, it is understood that the electronic message 112 may be another type of message that is capable of being electronically delivered (e.g., text message, Multimedia Message Service (MMS) message, etc.). The electronic message 112 is received from an internal source (e.g., an internal network 130), or an external source (e.g., an external network 128 configured to transmit SMS messages).

In at least one embodiment, the electronic message 112 is received at a corporate or business entity from a client of the entity. In such a situation, the electronic message 112 may be treated by the entity as a task item that is to be performed.

The account 110 is capable of being accessed by one or more users. As such, more than one user may access the account 110 at a particular time. For example, multiple users may concurrently access the account 110 at a given time. In at least one embodiment, the account 110 is a collaborative account that is accessible by multiple users and that has a single identifier (e.g., a single telephone number that identifies the account 110).

A message store 102 receives and stores the electronic message 112. For example, if the electronic message 112 is an SMS message, the message store 102 stores the electronic message 112 as an SMS message. Also, the message store 102 sends the electronic message 112 to join a message queue 106. At the message queue 106, the electronic message 112 may join one or other messages. For example, the electronic message 112 may join at least one other message that was received at the account 110 from the internal network 130 or the external network 128 at another time or times.

Messages in the message queue 106, including the electronic message 112, are presented for display at a user interface 108. Via the user interface 108, a user may select the electronic message 112 for reading and/or viewing.

Additionally, a notification is presented at a notification area 114 of the user interface 108. The notification effectively notifies the user that a new message (e.g., the electronic message 112) has arrived at the account 110. The notification may be considered as an original notification that is presented at the user interface 108 upon arrival of the electronic message 112 at the account 110. As noted earlier, the electronic message 112 may be treated by the entity as a task item that is to be performed. In this situation, the notification effectively informs the user that a newly received message that is the electronic message 112 (e.g., a new task item) is in need of attention and/or servicing.

In at least one embodiment, notifications (e.g., notifications similar to the notification presented at the notification area 114) are concurrently presented at one or more other platforms. For example, if the user interface 108 is configured by a web-based application, then notifications may be concurrently presented by a corresponding mobile-based application (e.g., an application configured for optimal execution at a mobile device such as a mobile telephone), a desktop application configured for optimal execution at a desktop computing device), etc. For example, a notification may be sent to the user via an alert at a mobile device. As such, it is possible that two or more notifications are concurrently presented to an individual user via different platforms.

In at least one embodiment, notifications are also presented to one or more additional users. As described earlier, the account 110 is capable of being accessed by one or more users. If one or more other users can access the account 110, then these other users are also notified that the newly received message (e.g., the electronic message 112) has arrived at the account 110. These other users may receive the notifications via one or more platforms similar to platforms described earlier.

Returning to the display of the user interface 108—as described earlier, the electronic message 112 is presented for display at the user interface 108. The user may then select the electronic message 112 for reading and/or viewing. For example, the electronic message 112 may be presented as a new conversation. In this situation, the user may select to enter the conversation, in order to read the contents of the electronic message 112.

In response to the user selecting the electronic message 112 for reading and/or viewing, the system 100 autonomously marks the message as having been read. For example, a messaging microservice 122 controls the updating of metadata 104 corresponding to the electronic message 112. In this manner, the messaging microservice 122 effectively updates the metadata 104 to reflect a modified status 116 of the electronic message 112 (e.g., from as being unread to as having been read). In at least one embodiment, the metadata 104 includes a status flag (e.g., a binary status flag) indicating whether the electronic message 112 has been read or not read by at least one user of the system 100. In such a situation, the messaging microservice 122 controls the updating of the metadata 104, such that the flag will indicate that the electronic message 112 has been read.

In at least one embodiment, the user interface 108 provides, in some manner, a visual indicator to inform the user that the status 116 of the electronic message 112 has been modified. For example, a message bubble that is displayed at the user interface 108 may fade away. As another example, a color or shade of according to which the electronic message 112 is displayed at the user interface 108 is changed. According to a particular example, the color according to which the electronic message 112 is displayed is changed from a darker color (or darker shade) to a lighter color (or lighter shade) as the status 116 of the electronic message 112 is changed from unread to read.

In at least one embodiment, the selection, by an individual user, of the electronic message 112 for reading and/or viewing also causes a same (or similar) visual indicator to be provided at other user interfaces. As described earlier, the account 110 is capable of being accessed by one or more users. If one or more other users can access the account 110, then these other users are also informed that the status 116 of the electronic message 112 has been changed. Accordingly, when one user selects the electronic message 112 for reading and/or viewing, the status 116 of the electronic message 112 is changed from unread to read, such that other users accessing the account 110 are also informed that the status 116 of the electronic message 112 has changed to read.

In response to the user selecting the electronic message 112 for reading and/or viewing, one or more message options 118 may be presented to the user via the user interface 108. In at least one embodiment, the message options 118 include forward, delete and mark as unread 120. In response to the user selecting the forward option, the electronic message 112 is forwarded (e.g., to another user of the system 100). In response to the user selecting the delete option, the electronic message 112 is deleted. For example, the electronic message 112 is deleted from the message store 102.

In response to the user selecting mark as unread 120, the system 100 changes the status 116 of the electronic message 112 from as having been read back to as being unread. For example, an application program interface (API) call is generated. The API call is sent to the messaging microservice 122. Upon receiving the API call, the messaging microservice 122 again controls the updating of the metadata 104 corresponding to the electronic message 112. In this manner, the messaging microservice 122 effectively updates the metadata 104 to reflect a modified status 116 of the electronic message 112 (e.g., from as having been read, back to as being unread).

The changing of the status 116 of the electronic message 112 from read back to unread is not caused by any additional message (e.g., any additional new message) being received at the account 110 and/or stored at the message store 102. Rather, the changing of the status 116 is caused by the user selection of mark as unread 120. Nevertheless, according to at least one embodiment, the changing of the status 116 of the electronic message 112 from read back to unread triggers another notification to be presented at the user interface 108. For example, the messaging microservice 122 causes another notification to be displayed at the notification area 114. In at least one embodiment, this other notification is the same as (or similar to) the notification that had been presented earlier, when the electronic message 112 arrived at the account 110. This other notification effectively notifies the user that the electronic message 112 (e.g., a task item corresponding to the electronic message 112) remains in need of attention and/or servicing. As such, changing the status 116 causes the other notification to be sent, while bypassing (or requiring) an additional message (or additional messages) being stored at the message store 102.

In at least one embodiment, similar notifications are concurrently presented to the user at one or more other platforms (e.g., mobile computing device, desktop computing device, etc.).

In at least one embodiment, similar notifications are concurrently presented to one or more other users. As described earlier, the account 110 is capable of being accessed by one or more users. If one or more other users can access the account 110, then these other users are also notified that the electronic message 112 (e.g., a task item corresponding to the electronic message 112) remains in need of attention and/or servicing. The other users may receive the notifications via one or more platforms similar to platforms described earlier.

An event log control memory structure 124 logs the changing of the status 116 of the electronic message 112. For example, the event log control memory structure 124 logs the changing of the status 116 from read to unread as an event. The event is logged for analysis by an analytics engine 126.

For the account 110, a count of unread messages is incremented in response to the changing of the status 116 of the electronic message 112 from read to unread. The count indicates the number of unread messages at the account 110. In at least one embodiment, the count is maintained at the message store 102.

For a particular message, selection of mark as unread 120 allows a user to effectively increase a priority level of the message. As noted earlier, the message may represent a task item that is to be performed or serviced. Instead of (or in addition to) flagging the message as a higher-priority item and/or forwarding the message to another user or users for servicing, the user may, in a more global manner, mark the message as unread. Accordingly, corresponding notifications may be presented at one or more platforms and/or other users having access to the account 110. As such, the message is treated as if it were a newly arrived message (e.g., a newly inbound message that is in need of some type of follow-up action by the entity or organization).

In a customer service environment employing text messages, such features may be beneficial in that text messages such as SMS messages are often regarded as a high-priority medium (e.g., a medium that is higher in priority than other mediums such as e-mail) for which shorter delays in responding are sought. By marking a particular message as unread, a user effectively identifies the message as remaining in need of attention and/or servicing, and, in a more global manner, draws the attention of one or more other users via notifications. As such, a priority level of the message is increased.

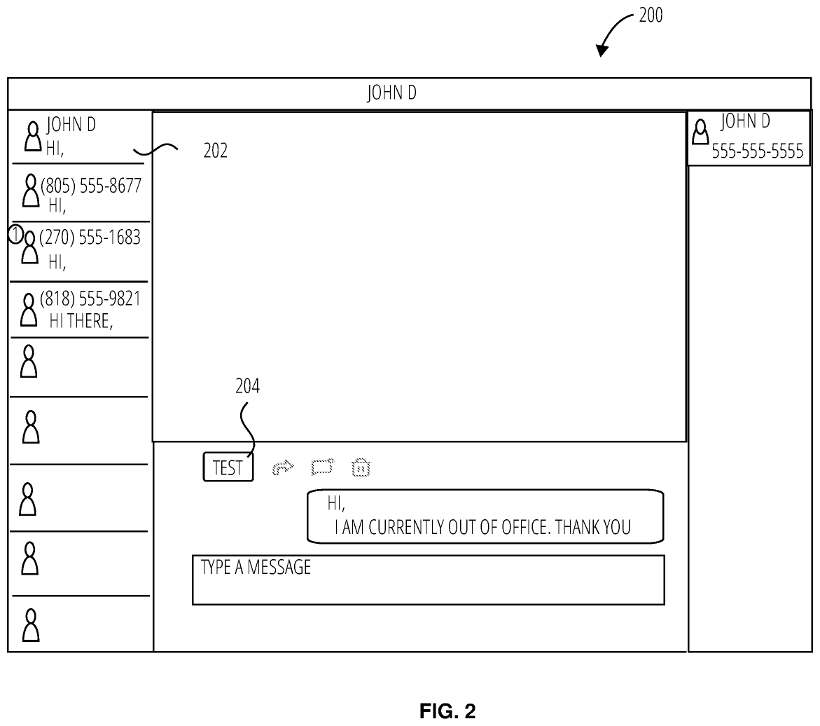

FIG. 2 illustrates an example of a screenshot 200 of a user interface (e.g., user interface 108). A message 202 (e.g., the electronic message 112) is presented for display. For example, the message 202 may be presented as a new conversation. In this situation, a user selects to enter the conversation, in order to read the contents 204 of the message 202.

In response to the selection of the message 202, the contents 204 of the message 202 are displayed. A visual indicator is provided to inform the user that the status (e.g., status 116) of the message 202 has been modified. For example, the color according to which the contents 204 are displayed is changed from a darker color (or darker shade) to a lighter color (or lighter shade) as the status (e.g., status 116) of the message 202 is changed from unread to read.

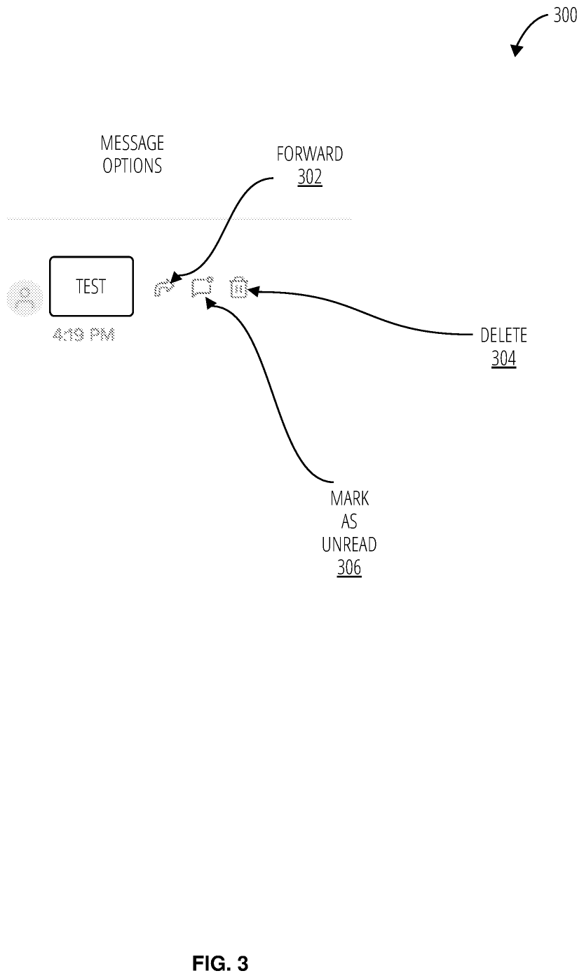

FIG. 3 illustrates an enlarged view 300 of a portion of the screenshot 200 of FIG. 2. As illustrated in FIG. 3, message options (e.g., message options 118) are displayed adjacent to contents of a message (e.g., contents 204 of the message 202). The message options include forward 302, delete 304, and mark as unread 306 (e.g., mark as unread 120). In response to the user selecting the forward 302 option, the message (e.g., message 202) is forwarded (e.g., to another user). In response to the user selecting the delete 304 option, the message is deleted. In response to the user selecting the mark as unread 306 option, the status (e.g., status 116) of the message is changed from as having been read, back to as being unread.

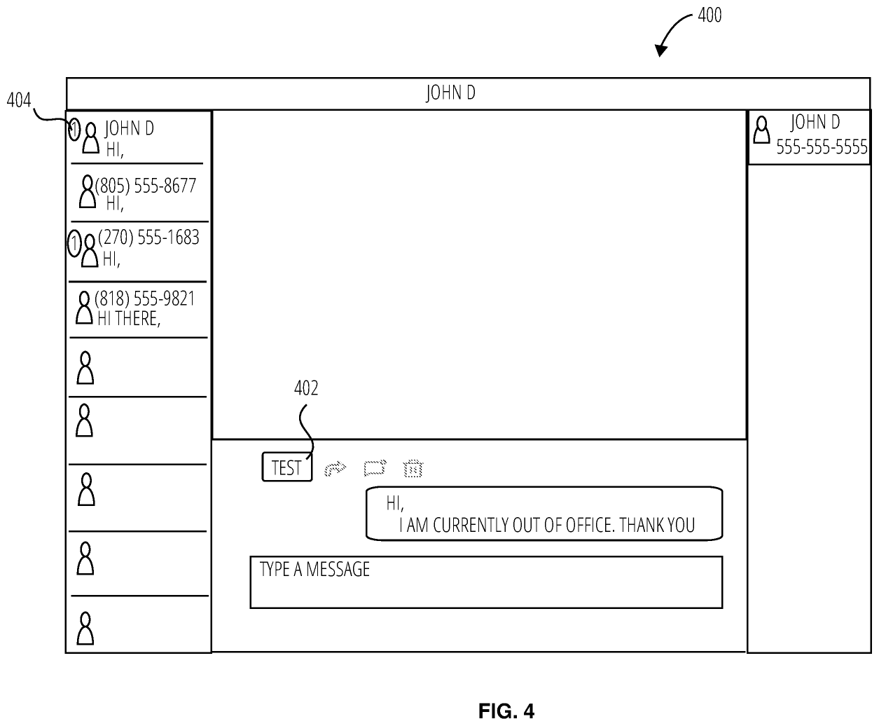

FIG. 4 illustrates an example of a screenshot 400 of a user interface (e.g., user interface 108). In response to the user selecting mark as unread 120, the status (e.g., status 116) of a message (e.g., message 202) is changed from as having been read, back to as being unread.

A visual indicator is provided to inform the user that the status (e.g., status 116) of the message has been modified. For example, the color according to which the contents 402 are displayed is changed from a lighter color (or lighter shade) to a darker color (or darker shade) as the status (e.g., status 116) of the message is changed from read back to unread.

A count 404 of unread messages is presented at the user interface. The count 404 is incremented in response to the changing of the status of the message from read to unread. The count 404 indicates the number of unread messages at the account (e.g., account 110).

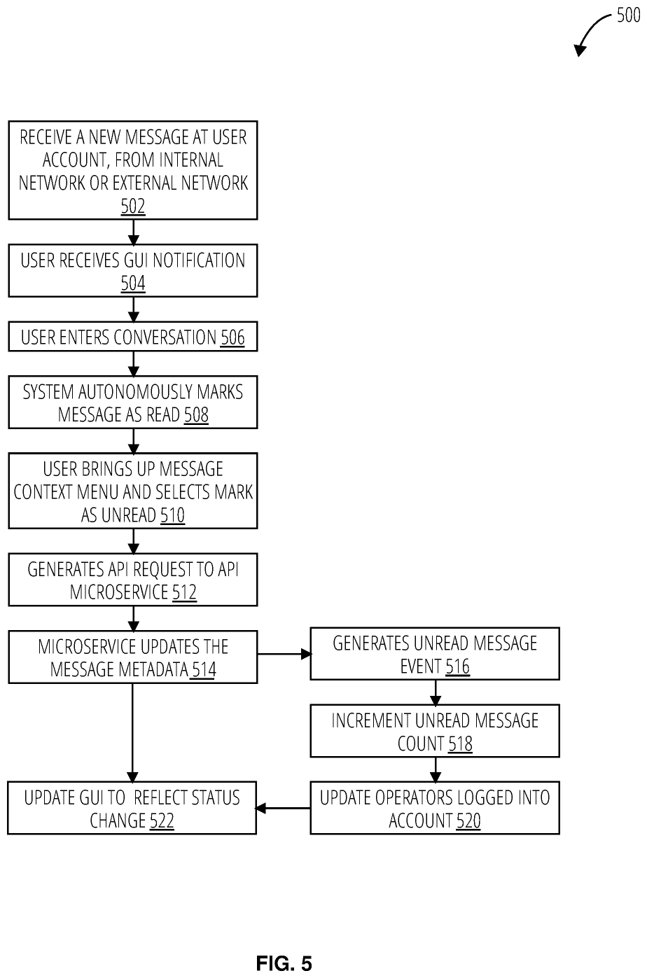

FIG. 5 is a flowchart of a method 500 of marking a message as unread, in accordance with at least one embodiment.

At block 502, a new message is received at a user account, from an internal network or an external network. For example, as described earlier with reference to FIG. 1, an electronic message 112 is received at an account 110 from an internal source (e.g., an internal network 130), or an external source (e.g., an external network 128 configured to transmit SMS messages).

At block 504, the user receives a graphical user interface (GUI) notification. For example, as described earlier with reference to FIG. 1, a notification is presented at a notification area 114 of the user interface 108. The notification effectively notifies the user that a new message (e.g., the electronic message 112) has arrived at the account 110.

At block 506, the user enters a conversation corresponding to the received message. For example, as described earlier with reference to FIG. 1, the user selects to enter the conversation, in order to read the contents of the electronic message 112.

At block 508, the system autonomously marks the message as having been read. For example, as described earlier with reference to FIG. 1, a messaging microservice 122 controls the updating of metadata 104 corresponding to the electronic message 112. In this manner, the messaging microservice 122 effectively updates the metadata 104 to reflect a modified status 116 of the electronic message 112 (e.g., from as being unread to as having been read).

At block 510, the user opens a message context menu, and selects a mark-as-unread option. For example, as described earlier with reference to FIG. 1, one or more message options 118 may be presented to the user via the user interface 108, where the message options 118 include forward, delete and mark as unread 120. The user selects mark as unread 120.

At block 512, an API request is generated and sent to an API microservice. For example, as described earlier with reference to FIG. 1, an API call is generated. The API call is sent to the messaging microservice 122.

At block 514, the microservice updates the message metadata. For example, as described earlier with reference to FIG. 1, upon receiving the API call, the messaging microservice 122 again controls the updating of the metadata 104 corresponding to the electronic message 112. In this manner, the messaging microservice 122 effectively updates the metadata 104 to reflect a modified status 116 of the electronic message 112 (e.g., from as having been read, back to as being unread).

At block 516, an unread message event is generated. For example, as described earlier with reference to FIG. 1, the changing of the status 116 of the electronic message 112 from read back to unread triggers another notification to be presented at the user interface 108. In addition, similar notifications are concurrently presented to the user at one or more other platforms (e.g., mobile computing device, desktop computing device, etc.).

At block 518, an unread message count is incremented. For example, as described earlier with reference to FIG. 1, a count of unread messages is incremented in response to the changing of the status 116 of the electronic message 112 from read to unread. The count indicates the number of unread messages at the account 110. The count may be maintained at the message store 102.

At block 520, operators logged into the account are also updated. For example, as described earlier with reference to FIG. 1, similar notifications are concurrently presented to one or more other users.

At block 522, the GUI is updated to reflect the change in the status of the message. For example, as described earlier with reference to FIG. 4, the color according to which the contents 402 are displayed is changed from a lighter color (or lighter shade) to a darker color (or darker shade) as the status (e.g., status 116) of the message is changed from read back to unread.

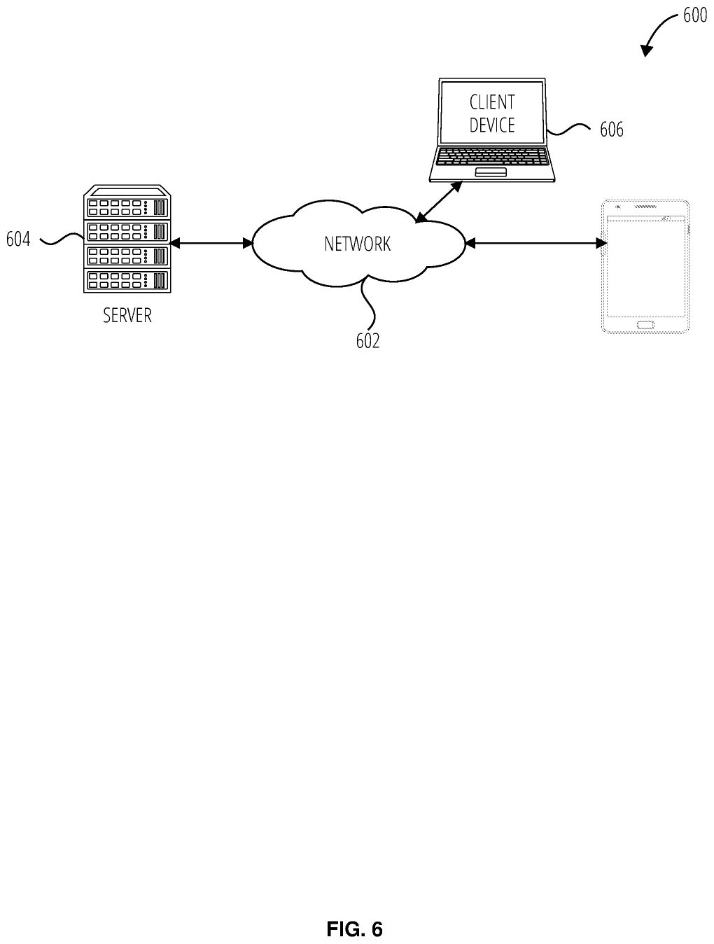

FIG. 6 illustrates a system 600 in which a server 604 and a client device 606 are connected to a network 602.

In various embodiments, the network 602 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 602 may also include a voice network that conveys not only voice communications, but also non-voice data such as Short message Service (“SMS”) messages, as well as data communicated via various cellular data communication protocols, and the like.

In various embodiments, the client device 606 may include desktop PCs, mobile phones, laptops, tablets, wearable computers, or other computing devices that are capable of connecting to the network 602 and communicating with the server 604, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 604 and the client device 606 may be implemented via various combinations of physical and/or logical devices. However, it is not necessary to show such infrastructure and implementation details in FIG. 6 in order to describe an illustrative embodiment.

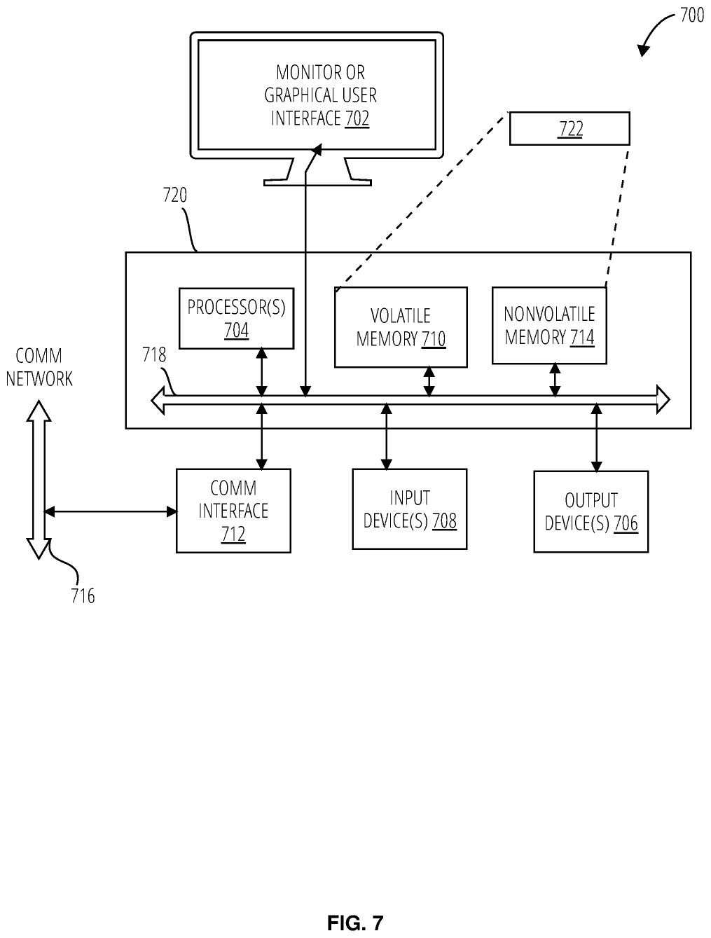

FIG. 7 is an example block diagram of a computing device 700 that may incorporate embodiments of the present invention. FIG. 7 is merely illustrative of a machine system to carry out aspects of the technical processes described herein, and does not limit the scope of the claims. One of ordinary skill in the art would recognize other variations, modifications, and alternatives. In one embodiment, the computing device 700 typically includes a monitor or graphical user interface 702, a data processing system 720, a communication network interface 712, input device(s) 708, output device(s) 706, and the like.

As depicted in FIG. 7, the data processing system 720 may include one or more processor(s) 704 that communicate with a number of peripheral devices via a bus subsystem 718. These peripheral devices may include input device(s) 708, output device(s) 706, communication network interface 712, and a storage subsystem, such as a volatile memory 710 and a nonvolatile memory 714.

The volatile memory 710 and/or the nonvolatile memory 714 may store computer-executable instructions and thus forming logic 722 that when applied to and executed by the processor(s) 704 implement embodiments of the processes disclosed herein.

The input device(s) 708 include devices and mechanisms for inputting information to the data processing system 720. These may include a keyboard, a keypad, a touch screen incorporated into the monitor or graphical user interface 702, audio input devices such as voice recognition systems, microphones, and other types of input devices. In various embodiments, the input device(s) 708 may be embodied as a computer mouse, a trackball, a track pad, a joystick, wireless remote, drawing tablet, voice command system, eye tracking system, and the like. The input device(s) 708 typically allow a user to select objects, icons, control areas, text and the like that appear on the monitor or graphical user interface 702 via a command such as a click of a button or the like.

The output device(s) 706 include devices and mechanisms for outputting information from the data processing system 720. These may include the monitor or graphical user interface 702, speakers, printers, infrared LEDs, and so on as well understood in the art.

The communication network interface 712 provides an interface to communication networks (e.g., communication network 716) and devices external to the data processing system 720. The communication network interface 712 may serve as an interface for receiving data from and transmitting data to other systems. Embodiments of the communication network interface 712 may include an Ethernet interface, a modem (telephone, satellite, cable, ISDN), (asynchronous) digital subscriber line (DSL), FireWire, USB, a wireless communication interface such as Bluetooth or Wi-Fi, a near field communication wireless interface, a cellular interface, and the like.

The communication network interface 712 may be coupled to the communication network 716 via an antenna, a cable, or the like. In some embodiments, the communication network interface 712 may be physically integrated on a circuit board of the data processing system 720, or in some cases may be implemented in software or firmware, such as “soft modems”, or the like.

The computing device 700 may include logic that enables communications over a network using protocols such as HTTP, TCP/IP, RTP/RTSP, IPX, UDP and the like.

The volatile memory 710 and the nonvolatile memory 714 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 710 and the nonvolatile memory 714 may be configured to store the basic programming and data constructs that provide the functionality of the disclosed processes and other embodiments thereof that fall within the scope of the present invention.

Logic 722 that implements embodiments of the present invention may be stored in the volatile memory 710 and/or the nonvolatile memory 714. Said logic 722 may be read from the volatile memory 710 and/or nonvolatile memory 714 and executed by the processor(s) 704. The volatile memory 710 and the nonvolatile memory 714 may also provide a repository for storing data used by the logic 722.

The volatile memory 710 and the nonvolatile memory 714 may include a number of memories including a main random-access memory (RAM) for storage of instructions and data during program execution and a read only memory (ROM) in which read-only non-transitory instructions are stored. The volatile memory 710 and the nonvolatile memory 714 may include a file storage subsystem providing persistent (non-volatile) storage for program and data files. The volatile memory 710 and the nonvolatile memory 714 may include removable storage systems, such as removable flash memory.

The bus subsystem 718 provides a mechanism for enabling the various components and subsystems of data processing system 720 communicate with each other as intended. Although the communication network interface 712 is depicted schematically as a single bus, some embodiments of the bus subsystem 718 may utilize multiple distinct busses.

It will be readily apparent to one of ordinary skill in the art that the computing device 700 may be a device such as a smartphone, a desktop computer, a laptop computer, a rack-mounted computer system, a computer server, or a tablet computer device. As commonly known in the art, the computing device 700 may be implemented as a collection of multiple networked computing devices. Further, the computing device 700 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

1. A method for marking a message as unread, the method comprising:
receiving an electronic message at an account;
controlling a user interface to display the electronic message;
receiving, via the user interface, a selection of the displayed message from a user;
in response to receiving the selection of the displayed message, setting a status of the displayed message as read, and controlling the user interface to display at least one message option for selection by the user, wherein the at least one message option comprises a mark-as-unread option; and
receiving, via the user interface, a selection of the mark-as-unread option for the displayed message;
in response to receiving the selection of the mark-as-unread option, setting the status of the displayed message as unread, wherein setting the status of the displayed message as unread causes a notification to be sent to at least the user, the notification indicating the displayed message as an unread message; and
the notification causing an increase in a priority level of the displayed message.

2. The method of claim 1, wherein the electronic message comprises a Short Message Service (SMS) message.

3. The method of claim 1, wherein the account is a collaborative account configured to be accessed by a plurality of users including the user.

4. The method of claim 3, wherein setting the status of the displayed message as unread causes the notification to be sent to the plurality of users.

5. The method of claim 4, further comprising:
in response to receiving the electronic message at the account, sending an original notification to the plurality of users, the original notification indicating the electronic message as a message newly received at the account.

6. The method of claim 1, further comprising:
in response to receiving the electronic message at the account, storing the electronic message at a message store.

7. The method of claim 6, wherein setting the status of the displayed message as unread causes the notification to be sent to at least the user and bypasses the storage of an additional message at the message store.

8. The method of claim 1, further comprising:
in response to receiving the selection of the displayed message, updating metadata corresponding to the displayed message to indicate that the displayed message is read.

9. The method of claim 8,
wherein updating the metadata comprises updating a status flag that indicates whether the displayed message is read or unread.

10. The method of claim 8, further comprising:
in response to receiving the selection of the mark-as-unread option, updating the metadata corresponding to the displayed message to indicate that the displayed message is unread.

11. The method of claim 1, wherein the setting of the status of the displayed message as unread causes the notification to be sent to at least the user via an alert at a mobile device.

12. A computing apparatus, the computing apparatus comprising:
a processor; and
a memory storing instructions that, when executed by the processor, configure the apparatus to:
receive an electronic message at an account;
control a user interface to display the electronic message;
receive, via the user interface, a selection of the displayed message from a user;
in response to receiving the selection of the displayed message, set a status of the displayed message as read, and control the user interface to display at least one message option for selection by the user, wherein the at least one message option comprises a mark-as-unread option; and
receive, via the user interface, a selection of the mark-as-unread option for the displayed message;
in response to receiving the selection of the mark-as-unread option, set the status of the displayed message as unread, wherein setting the status of the displayed message as unread causes a notification to be sent to at least the user, the notification indicating the displayed message as an unread message, increasing a priority level of the displayed message;
in response to receiving the electronic message at the account, storing the electronic message at a message store; and
wherein setting the status of the displayed message as unread causes the notification to be sent to at least the user and bypasses an additional message being stored at the message store.

13. The computing apparatus of claim 12, wherein the account is a collaborative account configured to be accessed by a plurality of users including the user.

14. The computing apparatus of claim 13, wherein setting the status of the displayed message as unread causes the notification to be sent to the plurality of users.

15. The computing apparatus of claim 14, wherein the instructions further configure the apparatus to:
in response to receiving the electronic message at the account, send an original notification to the plurality of users, the original notification indicating the electronic message as a message newly received at the account.

16. The computing apparatus of claim 12, wherein the instructions further configure the apparatus to:
in response to receiving the selection of the displayed message, update metadata corresponding to the displayed message to indicate that the displayed message is read.

17. The computing apparatus of claim 16,
wherein the metadata is updated by updating a status flag that indicates whether the displayed message is read or unread.

18. The computing apparatus of claim 16, wherein the instructions further configure the apparatus to:
in response to receiving the selection of the mark-as-unread option, update the metadata corresponding to the displayed message to indicate that the displayed message is unread.

19. The method of claim 1, further comprising:
incrementing an unread message count of unread messages in response to setting the status of the displayed message as unread.

20. The method of claim 19, wherein the incremented unread message count of unread messages is displayed on the user interface.
